(19) United States
(12) Patent Application Publication
(10) Pub. No.: US 2026/0155289 A1
(43) Pub. Date: Jun. 4, 2026

(54) MAGNETIC CORE ASSEMBLY FIXTURE AND POWER MODULE ASSEMBLY METHOD

(71) Applicant: Delta Electronics, Inc., Taoyuan City (TW)

(72) Inventors: Wenpei Shu, Shanghai (CN); Kun Jiang, Shanghai (CN)

(21) Appl. No.: 19/399,493

(22) Filed: Nov. 24, 2025

(30) Foreign Application Priority Data
Dec. 2, 2024 (CN) 202411752323.6

(51) Int. Cl. H01F 27/06; H01F 27/24

(52) U.S. Cl. CPC H01F 27/06; H01F 27/24

(57) ABSTRACT

The present disclosure provides a magnetic core assembly fixture and a power module assembly method. The magnetic core assembly fixture includes a first pressing module and a second pressing module. The first pressing module includes a first base plate, first elastic members and latches. The first elastic members are disposed on the first base plate, and configured to abut against the first magnetic cores on a connected-panel structure of a power module. The latches are disposed on the first base plate, and configured to engage with the connected-panel structure. The second pressing module includes a second base plate, second elastic members and latches. The second elastic members are disposed on the second base plate, and configured to abut against the second magnetic cores on the connected-panel structure. The latches are disposed on the second base plate, and configured to engage with first pressing module.

### CROSS-REFERENCE TO RELATED APPLICATION

This application claims priority to China Patent Application No. 202411752323.6, filed on Dec. 2, 2024. The entireties of the above-mentioned patent application are incorporated herein by reference for all purposes.

### FIELD OF THE INVENTION

The present disclosure relates to the field of magnetic core assembly, and more particularly to a magnetic core assembly fixture and a power module assembly method.

### BACKGROUND OF THE INVENTION

With the rapid development of artificial intelligence and data centers, DC power modules have become an indispensable component. DC power modules provide high energy efficiency and reduced energy loss, playing a key role in promoting sustainable energy development and intelligent technologies. The DC power module typically includes magnetic components, which leverage the physical and electrical properties thereof to control inductance, improve energy conversion efficiency, and enhance heat dissipation performance.

### SUMMARY OF THE INVENTION

It is an objective of the present disclosure to provide a magnetic core assembly fixture and a power module assembly method, which achieve the advantages of reducing component assembly tolerance, enhancing assembly precision, improving product yield, and reducing energy waste.

In accordance with an aspect of the present disclosure, there is provided a magnetic core assembly fixture for assembling a power module. The power module includes a connected-panel structure. The connected-panel structure includes a connected-panel substrate and a plurality of connected-panel units disposed within the connected-panel substrate. Each connected-panel unit includes a power board and a plurality of magnetic core assemblies. Each magnetic core assembly includes a first magnetic core and a second magnetic core disposed opposite to each other. The power board includes a plurality of magnetic core slots, and the magnetic core assemblies are disposed on the power board through the corresponding magnetic core slots. The power board has a first surface and a second surface opposite to each other. Each magnetic core slot penetrates through both the first surface and the second surface. The first magnetic core is disposed in the magnetic core slot on the first surface, and the second magnetic core is disposed in the magnetic core slot on the second surface. The magnetic core assembly fixture includes a first pressing module and a second pressing module. The first pressing module includes a first base plate, a plurality of first elastic members, a first latch and a second latch. The first base plate includes a plurality of first through holes. The plurality of first elastic members are disposed in the first through holes, and configured to abut against the first magnetic cores of the plurality of magnetic core assemblies. The first latch and the second latch are disposed on two opposite sides of the first base plate and corresponding to each other. An end of the first latch and an end of the second latch are configured to engage with the connected-panel structure. The second pressing module includes a second base plate, a plurality of second elastic members, a third latch and a fourth latch. The second base plate includes a plurality of second through holes. The plurality of second elastic members are disposed in the second through holes and configured to abut against the second magnetic cores of the plurality of magnetic core assemblies. The third latch and the fourth latch are disposed on two opposite sides of the second base plate and corresponding to each other. An end of the third latch and an end of the fourth latch are configured to engage with the first pressing module.

In accordance with another aspect of the present disclosure, there is provided a power module assembly method. The power module assembly method includes following steps: (a) providing a connected-panel structure, wherein the connected-panel structure includes a connected-panel substrate and a plurality of connected-panel units disposed within the connected-panel substrate, wherein each connected-panel unit includes a power board and a plurality of magnetic core assemblies, wherein each magnetic core assembly includes a first magnetic core and a second magnetic core corresponding to each other, wherein the power board includes a plurality of magnetic core slots, the magnetic core assemblies are disposed on the power board through the magnetic core slots, and the power board has a first surface and a second surface opposite to each other, each magnetic core slot includes a third surface and a fourth surface that are arranged opposite to each other, the third surface of the magnetic core slot is disposed close to the first surface of the power board and is recessed toward the second surface of the power board, the fourth surface of the magnetic core slot is disposed close to the second surface of the power board and is recessed toward the first surface of the power board; (b) allowing the first surface of the power board to face upward, and placing the first magnetic core into the magnetic core slot on the first surface; (c) providing a magnetic core assembly fixture, wherein the magnetic core assembly fixture includes a first pressing module and a second pressing module, wherein the first pressing module includes a first base plate, a plurality of first elastic members, a first latch and a second latch, wherein the plurality of first elastic members are respectively disposed on the first base plate, the first latch and the second latch are disposed on two opposite sides of the first base plate and corresponding to each other, wherein the second pressing module includes a second base plate, a plurality of second elastic members, a third latch and a fourth latch, wherein the plurality of second elastic members are disposed on the second base plate, and the third latch and the fourth latch are disposed on two opposite sides of the second base plate and corresponding to each other, wherein the first latch and second latch include hook parts, and the hook parts include first planes, respectively, wherein in a latched state, the first planes are parallel to the first base plate, allowing the connected-panel structure to be disposed between the first base plate and the first planes, and the first elastic members correspondingly abut against the first magnetic cores, wherein the third latch and the fourth latch include hook parts, and the hook parts include second planes, respectively, wherein in a latched state, the second planes are parallel to the second base plate, wherein the first base plate include contact surfaces; (d) flipping the first pressing module and the connected-panel structure, so that the second surface of the power board faces upward; (e) dispensing adhesive on the fourth surface and on the surface of the first magnetic core that is close to the second magnetic core, and placing the second magnetic cores into the magnetic core slots on the second surface; (f) allowing the connected-panel structure and the first pressing module to be disposed between the second base plate and the second planes, and allowing the second elastic members to abut against the second magnetic cores correspondingly; and (g) performing a high-temperature curing operation on the connected-panel structure, the first pressing module and the second pressing module, and removing the first pressing module and the second pressing module after the high-temperature curing operation, so that a power module is formed.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a perspective view illustrating a magnetic core assembly fixture and a power module according to an embodiment of the present disclosure;

FIG. 2 is an exploded view illustrating the magnetic core assembly fixture and the power module of FIG. 1;

FIG. 3 is another exploded view illustrating the magnetic core assembly fixture and the power module of FIG. 1 at another view angle;

FIG. 4 is a cross-sectional view illustrating the magnetic core assembly fixture and the power module of FIG. 1;

FIG. 5 is a cross-sectional view illustrating a first elastic member of the magnetic core assembly fixture of FIG. 1, wherein the first elastic member is in an initial state;

FIG. 6 is a cross-sectional view illustrating the first elastic member of the magnetic core assembly fixture of FIG. 1, wherein the first elastic member is in a compressed state;

FIG. 7 is a cross-sectional view illustrating a first pressing module of the magnetic core assembly fixture in an area A of FIG. 1;

FIG. 8 is a cross-sectional view illustrating the first pressing module of the magnetic core assembly fixture of FIG. 7, wherein the first pressing module is in an opened state;

FIG. 9A and FIG. 9B are flowcharts illustrating steps of a power module assembly method according to an embodiment of the present disclosure;

FIGS. 10 to 14 are cross-sectional views illustrating respective steps of the power module assembly method of FIG. 9A and FIG. 9B;

FIG. 15 is a detailed flowchart illustrating the step S3 of the power module assembly method of FIG. 9A;

FIG. 16 is a detailed flowchart illustrating the step S6 of the power module assembly method of FIG. 9B; and

FIG. 17 is a detailed flowchart illustrating the step S7 of the power module assembly method of FIG. 9B.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “upper,” “lower,” “front,” “rear,” “top,” “bottom,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

Generally speaking, the DC power module is suitable for automated production and includes a circuit board, a first magnetic component, and a second magnetic component. In the automated production process of the DC power module, the first magnetic component is connected to a first surface of the circuit board through a first gluing operation and a first high-temperature curing operation, and the second magnetic component is connected to a second surface of the circuit board through a second gluing operation and a second high-temperature curing operation, wherein the first surface and the second surface are two opposite surfaces of the circuit board. In the aforementioned automated production mode, before the glue is cured after the first magnetic component and the second magnetic component are assembled, the circuit board is subject to vibration during transportation on the conveyor line, which may cause the first magnetic component and the second magnetic component to be shifted. In addition, the glue may be expanded after multiple high-temperature curing operations, leading to changes in the gap between the first magnetic component and the second magnetic component. Consequently, the product yield is reduced. Furthermore, the aforementioned automated production process of the DC power module requires two high-temperature operations to fix the first magnetic component and the second magnetic component, which results in energy waste.

The following is a detailed description of some embodiments of the present disclosure in conjunction with the accompanying drawings. In the absence of conflict, the following embodiments and some features in the embodiments may be combined with each other. The same or similar concepts or processes may not be described in detail in some embodiments.

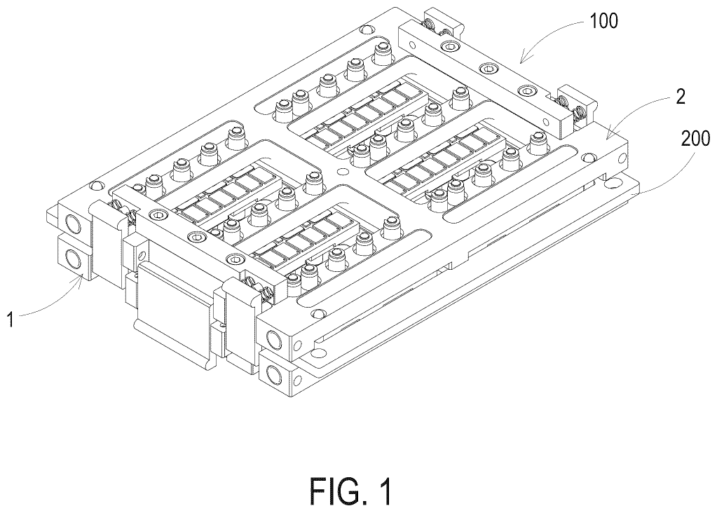

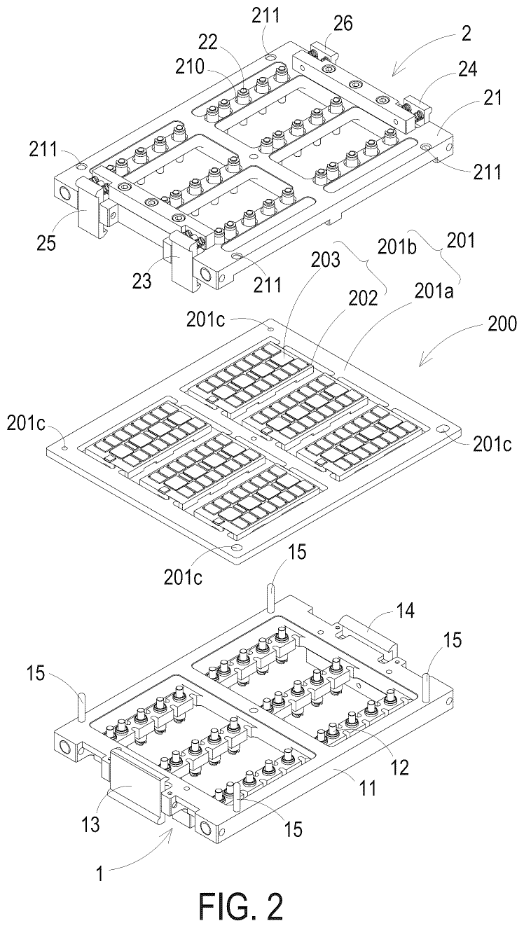

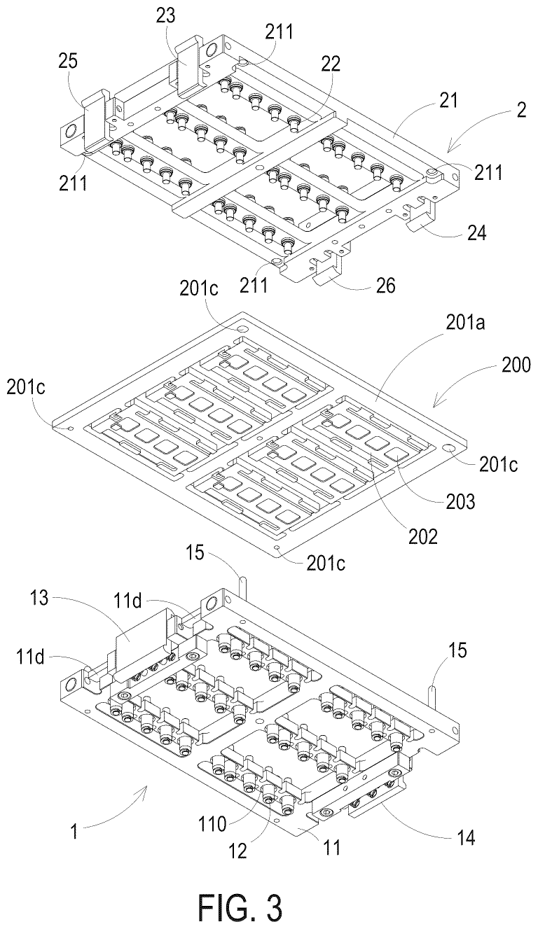

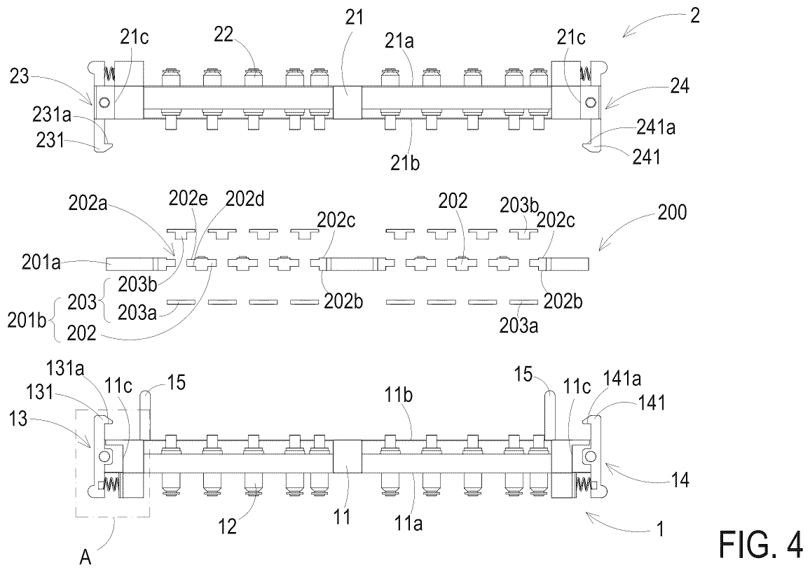

FIG. 1 is a perspective view illustrating a magnetic core assembly fixture and a power module according to an embodiment of the present disclosure, FIG. 2 is an exploded view illustrating the magnetic core assembly fixture and the power module of FIG. 1, FIG. 3 is another exploded view illustrating the magnetic core assembly fixture and the power module of FIG. 1 at another view angle, and FIG. 4 is a cross-sectional view illustrating the magnetic core assembly fixture and the power module of FIG. 1. As shown in FIG. 1 to FIG. 4, the magnetic core assembly fixture 100 of the present embodiment is adapted for assembling a power module 200. The power module 200 includes a connected-panel structure 201. The connected-panel structure 201 includes a connected-panel substrate 201a and a plurality of connected-panel units 201b disposed within the connected-panel substrate 201a. Each connected-panel unit 201b includes a power board 202 and a plurality of magnetic core assemblies 203. Each magnetic core assembly 203 includes a first magnetic core 203a and a second magnetic core 203b disposed corresponding to each other. In some embodiments, the first magnetic core 203a is an I-type magnetic core, and the second magnetic core 203b is a T-type magnetic core. The magnetic leg of the second magnetic core 203b is connected to the first magnetic core 203a. The power board 202 includes a plurality of magnetic core slots 202a (as shown in FIG. 4). The magnetic core assemblies 203 are bonded and disposed on the power board 202 through the corresponding magnetic core slots 202a. The power board 202 has a first surface 202b and a second surface 202c opposite to each other. Each magnetic core slot 202a penetrates through both the first surface 202b and the second surface 202c of the power board 202. Each magnetic core slot 202a includes a third surface 202d and a fourth surface 202e that are arranged opposite to each other. The third surface 202d of the magnetic core slot 202a is disposed close to the first surface 202b of the power board 202 and is recessed toward the second surface 202c of the power board 202. The fourth surface 202e of the magnetic core slot 202a is disposed close to the second surface 202c of the power board 202 and is recessed toward the first surface 202b of the power board 202. The first magnetic core 203a is disposed in the magnetic core slot 202a on the first surface 202b of the power board 202, and at least part of the first magnetic core 203a abuts against the third surface 202d of the magnetic core slot 202a. The second magnetic core 203b is disposed in the magnetic core slot 202a on the second surface 202c, and at least part of the second magnetic core 203b abuts against the fourth surface 202e of the magnetic core slot 202a.

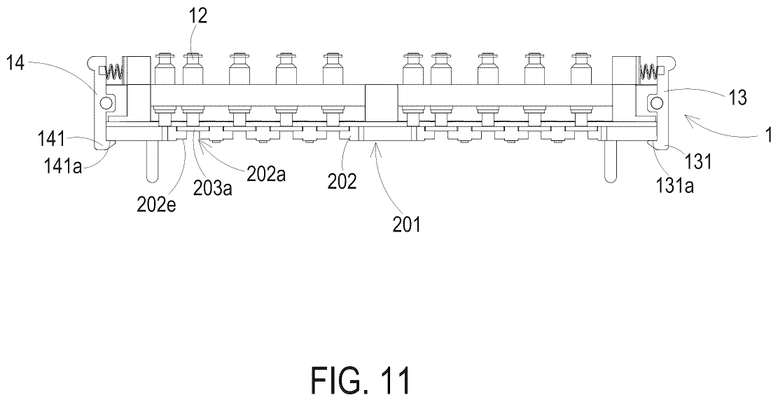

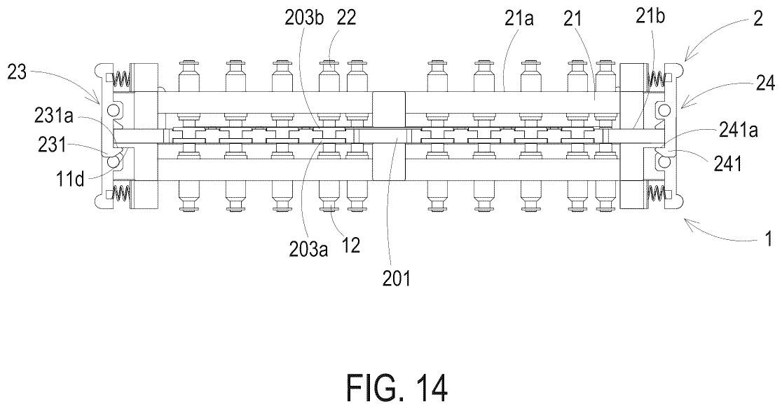

As shown in FIG. 1 to FIG. 4, in the present embodiment, the magnetic core assembly fixture 100 includes a first pressing module 1 and a second pressing module 2. The first pressing module 1 includes a first base plate 11, a plurality of first elastic members 12, a first latch 13, and a second latch 14. The first base plate 11 includes a plurality of first through holes 110. The plurality of first elastic members 12 are respectively disposed in the first through holes 110 and are configured to abut against the first magnetic cores 203a of the plurality of magnetic core assemblies 203 (as shown in FIG. 11). The first latch 13 and the second latch 14 are disposed on two opposite sides of the first base plate 11 and corresponding to each other. An end of the first latch 13 and an end of the second latch 14 are configured to engage with the connected-panel structure 201 of the power module 200 (as shown in FIG. 11). The second pressing module 2 includes a second base plate 21, a plurality of second elastic members 22, a third latch 23, and a fourth latch 24. The second base plate 21 includes a plurality of second through holes 210. The plurality of second elastic members 22 are disposed in the second through holes 210 and are configured to abut against the second magnetic cores 203b of the plurality of magnetic core assemblies 203 (as shown in FIG. 14). The third latch 23 and the fourth latch 24 are disposed on two opposite sides of the second base plate 21 and corresponding to each other. An end of the third latch 23 and an end of the fourth latch 24 are configured to engage with the first pressing module 1 (as shown in FIG. 14). By using the magnetic core assembly fixture 100 to clamp the first magnetic cores 203a between the first elastic members 12 and the power board 202 and clamp the second magnetic cores 203b between the second elastic members 22 and the power board 202, the risk of displacement of the first magnetic core 203a and second magnetic core 203b due to vibration before the adhesive is cured is reduced. Consequently, the product yield is enhanced. The connected-panel structure 201 and the magnetic core assembly fixture 100 require only a single high-temperature curing process to cure the adhesive between the first magnetic core 203a and the second magnetic core 203b of the connected-panel structure 201 and the power board 202, thereby avoiding the issue encountered from the conventional techniques where multiple high-temperature curing steps may cause changes in the core gap. Consequently, the advantages of enhancing the product yield and saving energy are achieved.

As shown in FIG. 1 to FIG. 4, in the present embodiment, the first pressing module 1 of the magnetic core assembly fixture 100 includes at least one positioning pin 15. The at least one positioning pin 15 is disposed on the first base plate 11. The connected-panel structure 201 includes at least one first positioning hole 201c. The at least one first positioning hole 201c is disposed corresponding to the at least one positioning pin 15 of the first pressing module 1. The second base plate 21 of the second pressing module 2 includes at least one second positioning hole 211. The at least one second positioning hole 211 is disposed corresponding to the at least one positioning pin 15 and the at least one first positioning hole 201c. The at least one positioning pin 15 removably penetrates through the at least one first positioning hole 201c and the at least one second positioning hole 211, thereby positioning the connected-panel structure 201 and the second pressing module 2 on the same side relative to the first pressing module 1. Consequently, the advantages of reducing assembly tolerance, improving component assembly precision and enhancing the product yield are achieved.

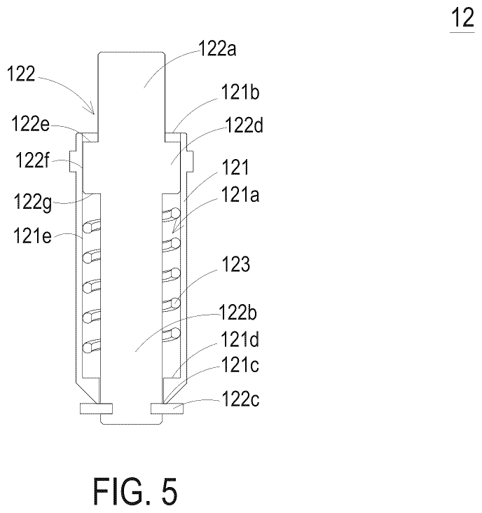

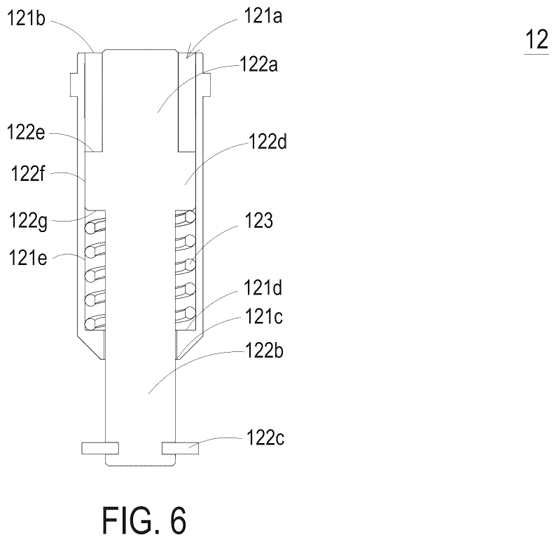

FIG. 5 is a cross-sectional view illustrating a first elastic member of the magnetic core assembly fixture of FIG. 1, wherein the first elastic member is in an initial state, and FIG. 6 is a cross-sectional view illustrating the first elastic member of the magnetic core assembly fixture of FIG. 1, wherein the first elastic member is in a compressed state. As shown in FIG. 4 to FIG. 6, in the present embodiment, the first elastic member 12 and the second elastic member 22 have the same structure. The first elastic member 12 includes a tubular body 121, an abutting unit 122, and an elastic unit 123. The tubular body 121 includes a receiving space 121a, a first opening 121b, and a second opening 121c. The first opening 121b and the second opening 121c are disposed on opposite sides of the receiving space 121a. The abutting unit 122 is disposed in the receiving space 121a and includes a head portion 122a, a tail portion 122b, and a stopper portion 122c. The head portion 122a is disposed corresponding to the first opening 121b. An end of the head portion 122a is connected to the tail portion 122b, and the other end of the head portion 122a is a free end. At least a portion of the head portion 122a protrudes from the receiving space 121a. An end of the tail portion 122b is connected to the head portion 122a, and the other end of the tail portion 122b is a free end, which correspondingly disposed at the second opening 121c. At least a portion of the tail portion 122b protrudes from the receiving space 121a. The stopper portion 122c is disposed on the tail portion 122b, corresponds to the second opening 121c, and located outside the receiving space 121a. The stopper portion 122c is configured to limit the movement range of the abutting unit 122. The width of the stopper portion 122c is greater than the width or diameter of the second opening 121c. The elastic unit 123 is disposed within the receiving space 121a and elastically supported between the head portion 122a and a bottom surface 121d of the tubular body 121. The bottom surface 121d is located inside the receiving space 121a and faces the first opening 121b. The first elastic member 12 is switched among plural states, which include an initial state and a pressing state. As shown in FIG. 5, in the initial state, the stopper portion 122c of the abutting unit 122 abuts against the second opening 121c of the tubular body 121 to limit the movement of the abutting unit 122. As shown in FIG. 6, in the pressing state, the head portion 122a of the abutting unit 122 is moved toward the receiving space 121a under force, the elastic unit 123 is compressed, and the stopper portion 122c of the abutting unit 122 is moved in a direction away from the second opening 121c. In the pressing state, the elastic unit 123 applies elastic force to the first magnetic core 203a (as shown in FIG. 11) via the abutting unit 122, so that the risk of displacement between the first magnetic core 203a, the second magnetic core 203b (specifically the magnetic leg of the second magnetic core 203b) and the power board 202 due to vibration before the adhesive is cured is reduced. Consequently, the product yield is enhanced. In addition, since the stopper portion 122c limits the movement of the abutting unit 122, the abutting unit 122 is prevented from detaching from the receiving space 121a, and the advantage of enhancing the overall stability of the device is achieved.

In the present embodiment, the second elastic member 22 has the same function and structure as the first elastic member 12, and will not be described in detail repeatedly. In the pressing state, the elastic unit of the second elastic member 22 applies an elastic force to the second magnetic core 203b through the abutting unit 122 (as shown in FIG. 14). Consequently, the risk of displacement between the second magnetic core 203b and the power board 202 due to vibration before the adhesive is cured is reduced, and the product yield is enhanced.

As shown in FIG. 4 to FIG. 6, in the present embodiment, the head portion 122a of the abutting unit 122 includes a blocking portion 122d. The blocking portion 122d is directly contacted with the elastic unit 123 and is configured to compress the elastic unit 123 under force. The blocking portion 122d extends from the head portion 122a in the direction toward the tubular body 121, and includes a first surface 122e, a second surface 122f, and a third surface 122g. The first surface 122e and the third surface 122g are opposite surfaces. The first surface 122e faces the first opening 121b, and the third surface 122g faces the second opening 121c. The second surface 122f is connected between the first surface 122e and the third surface 122g. The second surface 122f of the blocking portion 122d abuts against the inner surface 121e of the tubular body 121, and is movable in a direction parallel to the inner surface 121e of the tubular body 121. The elastic unit 123 is elastically supported between the third surface 122g of the blocking portion 122d and the bottom surface 121d of the tubular body 121. Due to the arrangement of the blocking portion 122d, the elastic unit 123 directly applies elastic force to the abutting unit 122 and allows the abutting unit 122 to move in a direction parallel to the inner surface 121e of the tubular body 121. Consequently, the overall stability of the device is enhanced.

As shown in FIG. 2 to FIG. 4, in the present embodiment, the first base plate 11 of the first pressing module 1 includes a first base plate top surface 11a and a first base plate bottom surface 11b opposite to each other. The first base plate bottom surface 11b is disposed adjacent to the connected-panel structure 201. The first base plate 11 includes a plurality of first base plate side surfaces 11c, which are connected between the first base plate top surface 11a and the first base plate bottom surface 11b. The first latch 13 and the second latch 14 are disposed on two opposite first base plate side surfaces 11c of the first base plate 11, respectively, and are configured to be elastically rotated to engage with the first pressing module 1 and the connected-panel structure 201.

As shown in FIG. 2 to FIG. 4, in the present embodiment, the first latch 13 and the second latch 14 include hook parts 131 and 141, respectively. The hook parts 131 and 141 include first planes 131a and 141a, respectively. When the first latch 13 and the second latch 14 are in a latched state, the first planes 131a and 141a are parallel to the first base plate bottom surface 11b of the first base plate 11, and the first base plate bottom surface 11b is disposed adjacent to the first planes 131a and 141a. The vertical distance between the first base plate bottom surface 11b and the first planes 131a and 141a is greater than the height of the connected-panel structure 201, which allows the connected-panel structure 201 to be accommodated between the first base plate bottom surface 11b and the first planes 131a and 141a.

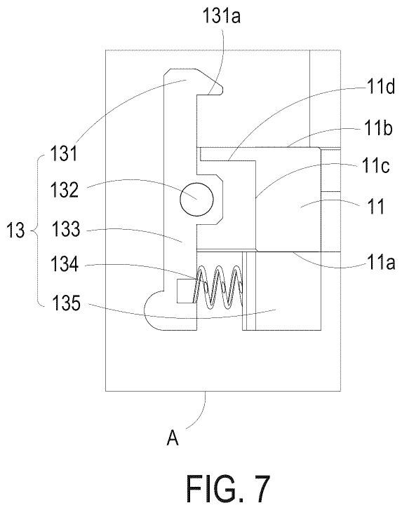

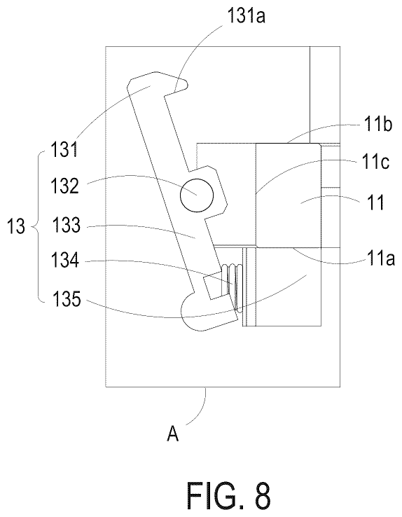

FIG. 7 is a cross-sectional view illustrating a first pressing module of the magnetic core assembly fixture in an area A of FIG. 4, and FIG. 8 is a cross-sectional view illustrating the first pressing module of the magnetic core assembly fixture of FIG. 7, wherein the first pressing module is in an open state. As shown in FIG. 1 to FIG. 4, FIG. 7 and FIG. 8, the first latch 13 includes a hook part 131, a pivot shaft 132, an arm portion 133, a spring 134, and a protrusion 135. The hook part 131 is disposed at an end of the arm portion 133. The pivot shaft 132 is connected to the first base plate side surface 11c of the first base plate 11. The arm portion 133 is rotatably connected to the pivot shaft 132. The protrusion 135 is disposed on the first base plate top surface 11a and extends in a direction away from the first base plate bottom surface 11b. An end of the spring 134 is connected to an end of the arm portion 133 opposite to the hook part 131, and the other end of the spring 134 is connected to the protrusion 135. The spring 134 is configured to provide elastic support between the arm portion 133 and the protrusion 135. The first latch 13 is capable of being switched among a plurality of states, which include a switchable latched state and open state. As shown in FIG. 7, in the latched state, the spring 134 of the first latch 13 is not compressed, and the first plane 131a of the hook part 131 is parallel to the first base plate bottom surface 11b. As shown in FIG. 8, in the open state, the spring 134 of the first latch 13 is compressed by an external force, which causes the arm portion 133 to rotate along the pivot shaft 132, and the hook part 131 to move in a direction away from the first base plate 11, thereby facilitating the assembly of the connected-panel structure 201. When the external force is removed, the first latch 13 returns from the open state to the latched state, so that the advantage of quick disassembly and reassembly of the connected-panel structure 201 is achieved. In the present embodiment, the second latch 14 has the same function and structure as the first latch 13, and will not be described redundantly.

As shown in FIG. 1 to FIG. 4, in the present embodiment, the second base plate 21 of the second pressing module 2 includes a second base plate top surface 21a and a second base plate bottom surface 21b opposite to each other. The second base plate bottom surface 21b is disposed adjacent to the connected-panel structure 201. The second base plate 21 includes a plurality of second base plate side surfaces 21c. The third latch 23 and the fourth latch 24 are disposed on two opposite second base plate side surfaces 21c, respectively, and are configured to be elastically rotated to engage with the first pressing module 1 and the second pressing module 2.

As shown in FIG. 4, in the present embodiment, the third latch 23 and the fourth latch 24 include hook parts 231 and 241, respectively. The hook parts 231 and 241 include second planes 231a and 241a, respectively. When the third latch 23 and the fourth latch 24 are in the latched state, the second planes 231a and 241a are parallel to the second base plate bottom surface 21b of the second base plate 21.

As shown in FIG. 2 and FIG. 3, in the present embodiment, the second pressing module 2 includes a fifth latch 25 and a sixth latch 26. The fifth latch 25 and the sixth latch 26 are disposed on two opposite second base plate side surfaces 21c of the second base plate 21, respectively, and are configured to be elastically rotated to engage with the first pressing module 1 and the second pressing module 2. In the present embodiment, the third latch 23, the fourth latch 24, the fifth latch 25 and the sixth latch 26 have the same functions and structures as the first latch 13, and will not be described redundantly.

As shown in FIG. 3, in the present embodiment, the first base plate 11 includes a plurality of contact surfaces 11d. The contact surfaces 11d are configured to abut against the second planes 231a and 241a of the third latch 23 and the fourth latch 24, respectively. The second base plate bottom surface 21b is disposed adjacent to the second planes 231a and 241a. The vertical distance between the second base plate bottom surface 21b and the second planes 231a and 241a is greater than the vertical distance between the second surface 202c of the power board 202 and the contact surfaces 11d, so that the first pressing module 1 and the connected-panel structure 201 can be accommodated between the second base plate bottom surface 21b and the second planes 231a and 241a (as shown in FIG. 14).

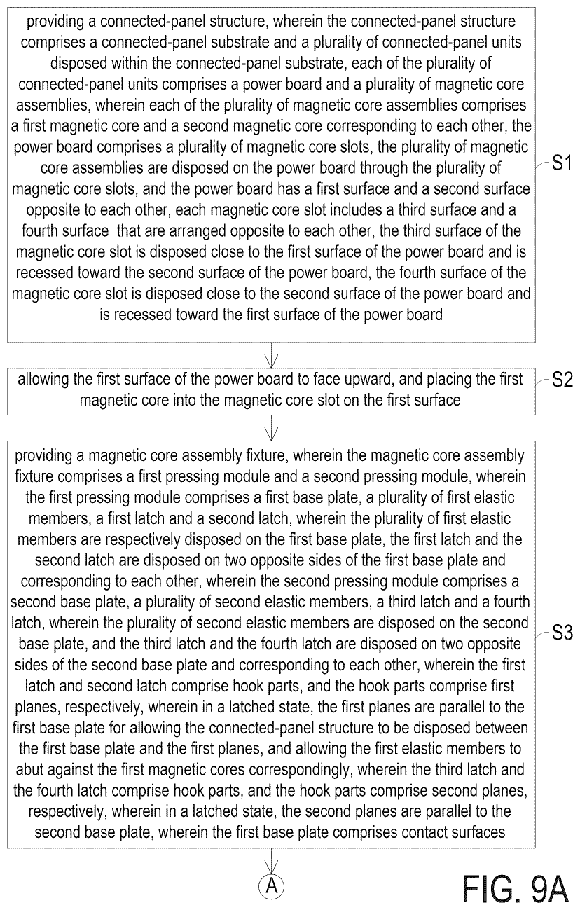

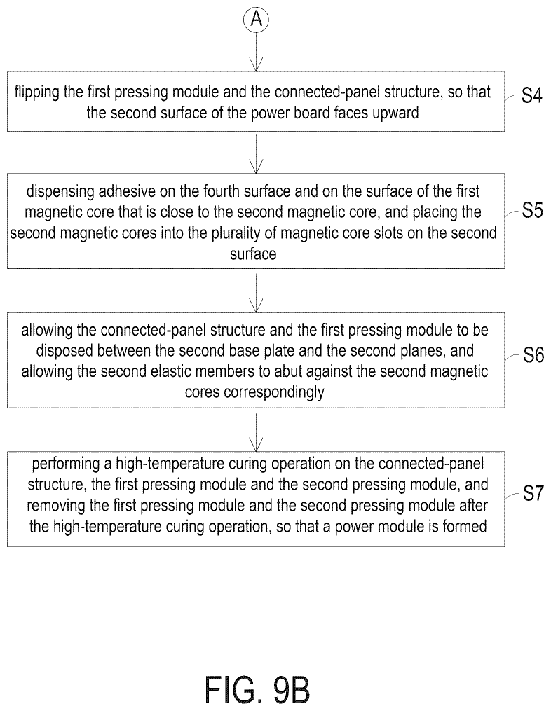

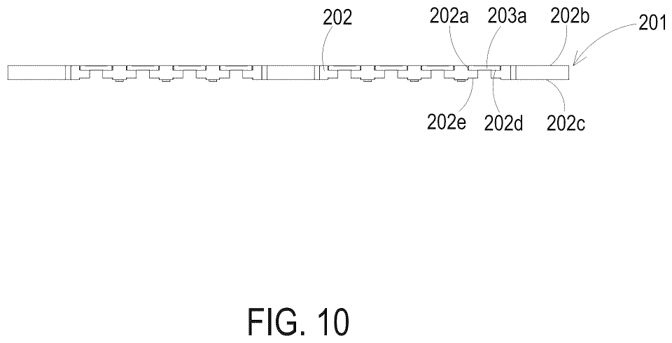

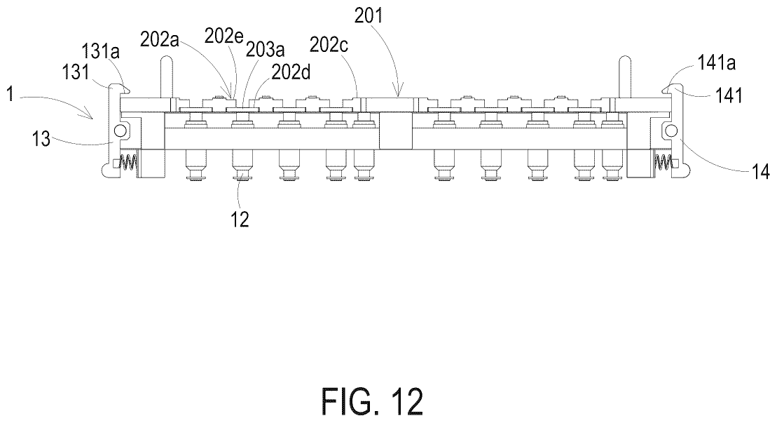

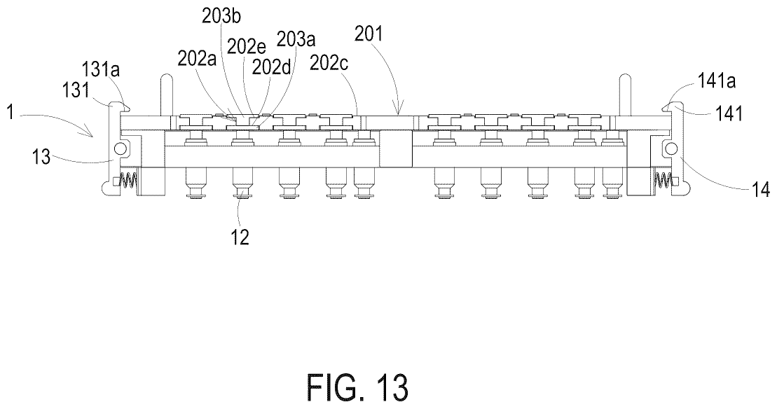

FIG. 9A and FIG. 9B are flowcharts illustrating steps of a power module assembly method according to an embodiment of the present disclosure, and FIGS. 10 to 14 are cross-sectional views illustrating respective steps of the power module assembly method of FIG. 9A and FIG. 9B. As shown in FIG. 9A to FIG. 14, the power module assembly method of the present embodiment includes the following steps. First, in Step S1, a connected-panel structure 201 is provided. The connected-panel structure 201 includes a connected-panel substrate 201a and a plurality of connected-panel units 201b disposed within the connected-panel substrate 201a. Each connected-panel unit 201b includes a power board 202 and a plurality of magnetic core assemblies 203. Each magnetic core assembly 203 includes a first magnetic core 203a and a second magnetic core 203b, which are disposed corresponding to each other. The power board 202 includes a plurality of magnetic core slots 202a. The magnetic core assemblies 203 are disposed on the power board 202 through the magnetic core slots 202a. The power board 202 has a first surface 202b and a second surface 202c opposite to each other. Each magnetic core slot 202a penetrates through the first surface 202b and the second surface 202c of the power board 202. Each magnetic core slot 202a includes a third surface 202d and a fourth surface 202e that are arranged opposite to each other. The third surface 202d of the magnetic core slot 202a is disposed close to the first surface 202b of the power board 202 and is recessed toward the second surface 202c of the power board 202. The fourth surface 202e of the magnetic core slot 202a is disposed close to the second surface 202c of the power board 202 and is recessed toward the first surface 202b of the power board 202. Then, in Step S2, allow the first surface 202b of the power board 202 to face upward, and the first magnetic core 203a is placed into the magnetic core slot 202a on the first surface 202b, as shown in FIG. 10. Thereafter, in Step S3, a magnetic core assembly fixture 100 is provided as shown in FIGS. 1 to 8. The first latch 13 and the second latch 14 of the first pressing module 1 include hook parts 131, 141, and the hook parts 131, 141 include first planes 131a, 141a, respectively. In a latched state, the first planes 131a, 141a are parallel to the first base plate 11, allowing the connected-panel structure 201 to be disposed between the first base plate 11 and the first planes 131a, 141a. The first elastic members 12 correspondingly abut against the first magnetic cores 203a, as shown in FIG. 11. The third latch 23 and the fourth latch 24 of the second pressing module 2 include hook parts 231, 241, and the hook parts 231, 241 include second planes 231a, 241a, respectively. In the latched state, the second planes 231a, 241a are parallel to the second base plate 21. The first base plate 11 includes contact surfaces 11d (as shown in FIG. 3), which abut against the second planes 231a, 241a. Then, in Step S4, the first pressing module 1 and the connected-panel structure 201 are flipped, so that the second surface 202c of the power board 202 faces upward, as shown in FIG. 12. Next, in Step S5, an adhesive is dispensed on the fourth surface 202e and on the surface of the first magnetic core 203a that is close to the second magnetic core 203b, and the second magnetic cores 203b is placed into the magnetic core slots 202a on the second surface 202c. And at least a portion of the second magnetic core 203b abuts against the fourth surface 202e of the magnetic core slot 202a, and the magnetic leg of the second magnetic core 203b abut against the surface of the first magnetic core 203a that is close to the second magnetic core 203b, as shown in FIG. 13. Then, in Step S6, allow the connected-panel structure 201 and the first pressing module 1 to be disposed between the second base plate 21 and the second planes 231a, 241a. The second elastic members 22 correspondingly abut against the second magnetic cores 203b, as shown in FIG. 14. Finally, in Step S7, a high-temperature curing operation on the connected-panel structure 201, the first pressing module 1 and the second pressing module 2 is performed, and the first pressing module 1 and the second pressing module 2 are removed after the high-temperature curing operation, so that a power module 200 is formed.

In an embodiment, the force exerted on the second magnetic core 203b by the second elastic member 22 is greater than the force exerted on the first magnetic core 203a by the first elastic member 12.

In an embodiment, the first base plate bottom surface 11b is disposed adjacent to the first planes 131a and 141a. The vertical distance between the first base plate bottom surface 11b and the first planes 131a, 141a is greater than the height of the connected-panel structure 201, which allows the first pressing module 1 and the connected-panel structure 201 to be accommodated between the second base plate bottom surface 21b and the second planes 231a and 241a.

In an embodiment, the second base plate bottom surface 21b is disposed adjacent to the second planes 231a and 241a. The vertical distance between the second base plate bottom surface 21b and the second planes 231a, 241a is greater than the vertical distance between the second surface 202c of the power board 202 and the contact surface 11d, which allows the first pressing module 1 and the connected-panel structure 201 to be accommodated between the second base plate bottom surface 21b and the second planes 231a and 241a.

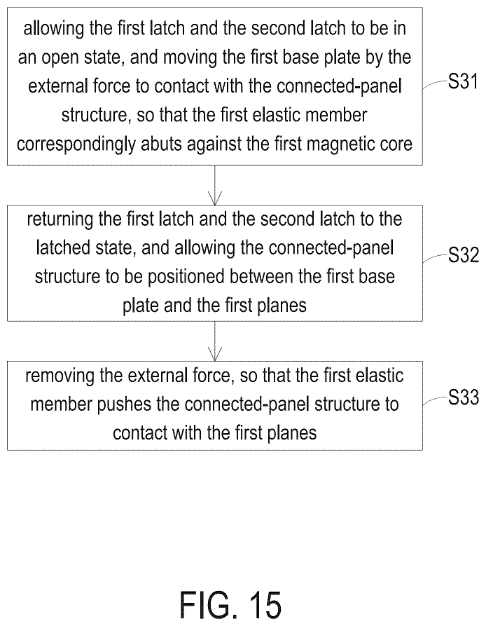

FIG. 15 is a detailed flowchart illustrating the step S3 of the power module assembly method of FIG. 9A. As shown in FIG. 7, FIG. 8, FIG. 11 and FIG. 15, in the present embodiment, the step S3 of the power module assembly method includes the following sub-steps. First, in step S31, allow the first latch 13 and the second latch 14 to be in the open state (as shown in FIG. 8), and the first base plate 11 is moved by the external force to contact with the connected-panel structure 201, so that the first elastic member 12 correspondingly abuts against the first magnetic core 203a. Then, in step S32, the first latch 13 and the second latch 14 is returned to the latched state (as shown in FIG. 7), which allows the connected-panel structure 201 to be positioned between the first base plate 11 and the first planes 131a and 141a. Finally, in step S33, the external force is removed, so that the first elastic member 12 pushes the connected-panel structure 201, and the first planes 131a and 141a are in contact with the connected-panel structure 201 (as shown in FIG. 11).

In an embodiment, during step S5 of the power module assembly method, a first external force is firstly applied to move the first base plate 11 to contact with the connected-panel structure 201, and then adhesive is dispensed into the magnetic core slot 202a on the second surface 202c. By applying the first external force to move the first base plate 11 to contact with the connected-panel structure 201, the elastic force exerted by the first elastic member 12 on the first magnetic core 203a is increased. Consequently, the risk of adhesive overflow from the magnetic core slot 202a is reduced.

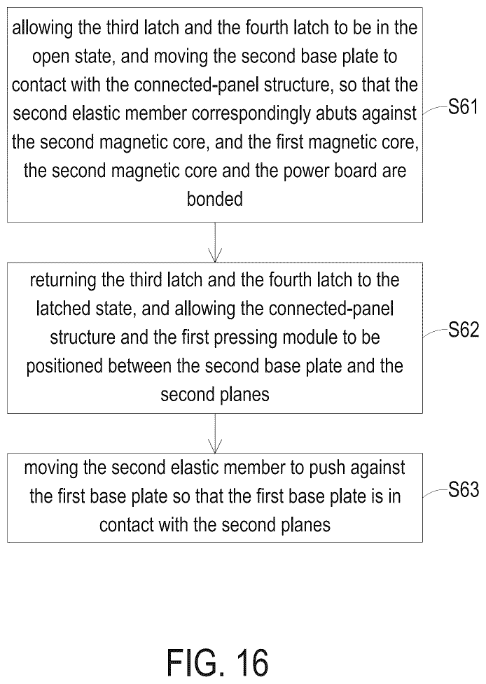

FIG. 16 is a detailed flowchart illustrating the step S6 of the power module assembly method of FIG. 9B. As shown in FIG. 16, in the present disclosure, the step S6 of the power module assembly method includes the following sub-steps. First, in step S61, allow the third latch 23 and the fourth latch 24 to be in the open state, and the second base plate 21 is moved to contact with the connected-panel structure 201, so that the second elastic member 22 correspondingly abuts against the second magnetic core 203b, and the first magnetic core 203a, the second magnetic core 203b and the power board 202 are bonded. Then, in step S62, the third latch 23 and the fourth latch 24 are returned to the latched state, which allows the connected-panel structure 201 and the first pressing module 1 to be positioned between the second base plate 21 and the second planes 231a and 241a. Finally, in step S63, allow the second elastic member 22 to push the first base plate 11 to contact with the second planes 231a and 241a. By the above-mentioned steps, the advantage of quick assembly of the connected-panel structure 201 and the first pressing module 1 is achieved

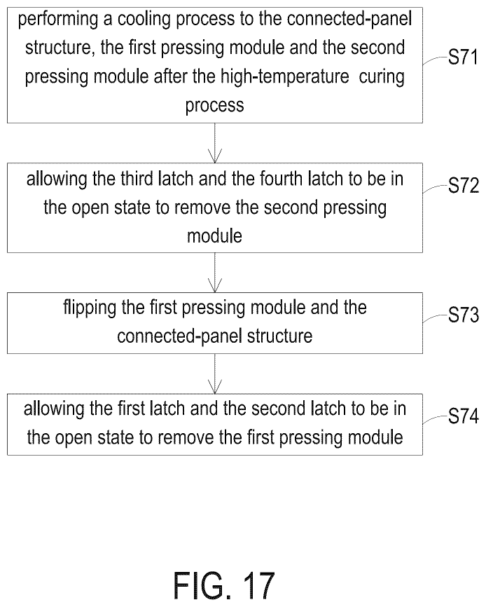

FIG. 17 is a detailed flowchart illustrating the step S7 of the power module assembly method of FIG. 9B. As shown in FIG. 17, in the present disclosure, the step S7 of the power module assembly method includes the following sub-steps. First, in step S71, a cooling process to the connected-panel structure 201, the first pressing module 1, and the second pressing module 2 are performed after the high-temperature curing process. Then, in step S72, the third latch 23 and the fourth latch 24 are in the open state to remove the second pressing module 2. Then, in step S73, the first pressing module 1 and the connected-panel structure 201 are flipped. Finally, in step S74, the first latch 13 and the second latch 14 are in the open state to remove the first pressing module 1. By the above-mentioned steps, the first pressing module 1 and the second pressing module 2 can be quickly removed.

From above descriptions, the present disclosure provides a magnetic core assembly fixture and a power module assembly method. By using the magnetic core assembly fixture to clamp the first magnetic core between the first elastic member and the power board and clamp the second magnetic core between the second elastic member and the power board, the risk of displacement of the first and second magnetic cores due to vibration before the adhesive is cured is reduced, and the product yield is enhanced. In addition, the connected-panel structure and the magnetic core assembly fixture require only a single high-temperature curing process, which avoids the issue encountered from the conventional techniques where multiple high-temperature curing steps may cause changes in the core gap, and the advantages of enhancing the product yield and saving energy are achieved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic core assembly fixture for assembling a power module, wherein the power module comprises a connected-panel structure, the connected-panel structure comprises a connected-panel substrate and a plurality of connected-panel units disposed within the connected-panel substrate, wherein each of the plurality of connected-panel units comprises a power board and a plurality of magnetic core assemblies, each of the plurality of magnetic core assemblies comprises a first magnetic core and a second magnetic core corresponding to each other, wherein the power board comprises a plurality of magnetic core slots, the plurality of magnetic core assemblies are disposed on the power board through the corresponding magnetic core slots, the power board has a first surface and a second surface opposite to each other, wherein each of the plurality of magnetic core slots penetrates through both the first surface and the second surface, the first magnetic core is disposed in the magnetic core slot on the first surface, and the second magnetic core is disposed in the magnetic core slot on the second surface, wherein the magnetic core assembly fixture comprises:
a first pressing module comprising:
a first base plate comprising a plurality of first through holes;
a plurality of first elastic members disposed in the first through holes, and configured to abut against the first magnetic cores of the plurality of magnetic core assemblies; and
a first latch and a second latch disposed on two opposite sides of the first base plate and corresponding to each other, wherein an end of the first latch and an end of the second latch are configured to engage with the connected-panel structure; and
a second pressing module comprising:
a second base plate comprising a plurality of second through holes;
a plurality of second elastic members disposed in the second through holes, and configured to abut against the second magnetic cores of the plurality of magnetic core assemblies; and
a third latch and a fourth latch disposed on two opposite sides of the second base plate and corresponding to each other, wherein an end of the third latch and an end of the fourth latch are configured to engage with the first pressing module.

2. The magnetic core assembly fixture according to claim 1, wherein the first pressing module comprises at least one positioning pin, and the at least one positioning pin is disposed on the first base plate, wherein the connected-panel structure comprises at least one first positioning hole, and the at least one first positioning hole is disposed corresponding to the at least one positioning pin, wherein the second base plate comprises at least one second positioning hole, and the at least one second positioning hole is disposed corresponding to the at least one positioning pin and the at least one first positioning hole, wherein the at least one positioning pin penetrates through the at least one first positioning hole and the at least one second positioning hole.

3. The magnetic core assembly fixture according to claim 1, wherein the first elastic member and the second elastic member have the same structure, and each of the first elastic member and the second elastic member comprises:
a tubular body comprising a receiving space, a first opening and a second opening, wherein the first opening and the second opening are disposed on opposite sides of the receiving space;
an abutting unit disposed in the receiving space and comprising a head portion, a tail portion and a stopper portion, wherein the head portion is disposed corresponding to the first opening, and an end of the head portion is connected to the tail portion, wherein the stopper portion is disposed on the tail portion, corresponds to the second opening, and located outside the receiving space; and
an elastic unit disposed within the receiving space and elastically supported between the head portion and the tubular body;
wherein the first elastic member and the second elastic member are switched between an initial state and a pressing state, wherein, in the initial state, the stopper portion abuts against the second opening to limit the movement of the abutting unit, wherein, in the pressing state, the head portion is moved toward the receiving space under force, the elastic unit is compressed, and the stopper portion is moved in a direction away from the second opening.

4. The magnetic core assembly fixture according to claim 3, wherein the head portion comprises a blocking portion, wherein the blocking portion is directly contacted with the elastic unit and is configured to compress the elastic unit under force.

5. The magnetic core assembly fixture according to claim 1, wherein the first base plate comprises a first base plate top surface and a first base plate bottom surface opposite to each other, wherein the first base plate comprises a plurality of first base plate side surfaces connected between the first base plate top surface and the first base plate bottom surface, wherein the first latch and the second latch are disposed on two opposite first base plate side surfaces of the first base plate, respectively, and are configured to be elastically rotated to engage with the first pressing module and the connected-panel structure.

6. The magnetic core assembly fixture according to claim 5, wherein the first latch and the second latch comprise hook parts, respectively, and the hook parts comprise first planes, wherein when the first latch and the second latch are in a latched state, the first planes are parallel to the first base plate, and the first base plate bottom surface is disposed adjacent to the first planes, wherein the vertical distance between the first base plate bottom surface and the first planes is greater than the height of the connected-panel structure.

7. The magnetic core assembly fixture according to claim 1, wherein the second base plate comprises a second base plate top surface and a second base plate bottom surface opposite to each other, wherein the second base plate comprises a plurality of second base plate side surfaces, the third latch and the fourth latch are disposed on two opposite second base plate side surfaces of the second base plate, respectively, and are configured to be elastically rotated to engage with the first pressing module and the second pressing module.

8. The magnetic core assembly fixture according to claim 7, wherein the second pressing module comprises a fifth latch and a sixth latch, wherein the fifth latch and the sixth latch are disposed on two opposite second base plate side surfaces of the second base plate, respectively, and are configured to be elastically rotated to engage with the first pressing module and the second pressing module.

9. The magnetic core assembly fixture according to claim 7, wherein the first base plate comprises a first base plate top surface and a first base plate bottom surface opposite to each other, wherein the third latch and the fourth latch comprise hook parts, respectively, and the hook parts comprise second planes, respectively, wherein when the third latch and the fourth latch are in a latched state, the second planes are parallel to the second base plate, wherein the first base plate comprises a contact surface configured to abut against the second planes, wherein the second base plate bottom surface is disposed adjacent to the second planes, wherein the vertical distance between the second base plate bottom surface and the second planes is greater than the vertical distance between the second surface of the power board and the contact surface.

10. A power module assembly method, comprising following steps:
(a) providing a connected-panel structure, wherein the connected-panel structure comprises a connected-panel substrate and a plurality of connected-panel units disposed within the connected-panel substrate, each of the plurality of connected-panel units comprises a power board and a plurality of magnetic core assemblies, wherein each of the plurality of magnetic core assemblies comprises a first magnetic core and a second magnetic core corresponding to each other, the power board comprises a plurality of magnetic core slots, the plurality of magnetic core assemblies are disposed on the power board through the plurality of magnetic core slots, and the power board has a first surface and a second surface opposite to each other, each magnetic core slot includes a third surface and a fourth surface that are arranged opposite to each other, the third surface of the magnetic core slot is disposed close to the first surface of the power board and is recessed toward the second surface of the power board, the fourth surface of the magnetic core slot is disposed close to the second surface of the power board and is recessed toward the first surface of the power board;
(b) allowing the first surface of the power board to face upward, and placing the first magnetic core into the magnetic core slot on the first surface;
(c) providing a magnetic core assembly fixture, wherein the magnetic core assembly fixture comprises a first pressing module and a second pressing module, wherein the first pressing module comprises a first base plate, a plurality of first elastic members, a first latch and a second latch, wherein the plurality of first elastic members are respectively disposed on the first base plate, the first latch and the second latch are disposed on two opposite sides of the first base plate and corresponding to each other, wherein the second pressing module comprises a second base plate, a plurality of second elastic members, a third latch and a fourth latch, wherein the plurality of second elastic members are disposed on the second base plate, and the third latch and the fourth latch are disposed on two opposite sides of the second base plate and corresponding to each other, wherein the first latch and second latch comprise hook parts, and the hook parts comprise first planes, respectively, wherein in a latched state, the first planes are parallel to the first base plate for allowing the connected-panel structure to be disposed between the first base plate and the first planes, and allowing the first elastic members to abut against the first magnetic cores correspondingly, wherein the third latch and the fourth latch comprise hook parts, and the hook parts comprise second planes, respectively, wherein in a latched state, the second planes are parallel to the second base plate, wherein the first base plate comprises contact surfaces;
(d) flipping the first pressing module and the connected-panel structure, so that the second surface of the power board faces upward;
(e) dispensing adhesive on the fourth surface and on the surface of the first magnetic core that is close to the second magnetic core, and placing the second magnetic cores into the plurality of magnetic core slots on the second surface;
(f) allowing the connected-panel structure and the first pressing module to be disposed between the second base plate and the second planes, and allowing the second elastic members to abut against the second magnetic cores correspondingly; and
(g) performing a high-temperature curing operation on the connected-panel structure, the first pressing module and the second pressing module, and removing the first pressing module and the second pressing module after the high-temperature curing operation, so that a power module is formed.

11. The power module assembly method according to claim 10, wherein the force exerted on the second magnetic core by the second elastic member is greater than the force exerted on the first magnetic core by the first elastic member.

12. The power module assembly method according to claim 10, wherein the first base plate bottom surface is disposed adjacent to the first planes, and the vertical distance between the first base plate bottom surface and the first planes is greater than the height of the connected-panel structure.

13. The power module assembly method according to claim 10, wherein the second base plate bottom surface is disposed adjacent to the second planes, and the vertical distance between the second base plate bottom surface and the second planes is greater than the vertical distance between the second surface of the power board and the contact surface.

14. The power module assembly method according to claim 10, wherein the step (c) comprises sub-steps:
(c1) allowing the first latch and the second latch to be in an open state, and moving the first base plate by the external force to contact with the connected-panel structure, so that the first elastic member correspondingly abuts against the first magnetic core;
(c2) returning the first latch and the second latch to the latched state, and allowing the connected-panel structure to be positioned between the first base plate and the first planes; and
(c3) removing the external force, so that the first elastic member pushes the connected-panel structure to contact with the first planes.

15. The power module assembly method according to claim 10, wherein in the step (e), a first external force is firstly applied to move the first base plate to contact with the connected-panel structure, and then the adhesive is dispensed on the fourth surface and on the surface of the first magnetic core that is close to the second magnetic core.

16. The power module assembly method according to claim 15, wherein the step (f) comprises sub-steps:
(f1) allowing the third latch and the fourth latch to be in the open state, and moving the second base plate to contact with the connected-panel structure, so that the second elastic member correspondingly abuts against the second magnetic core, and the first magnetic core, the second magnetic core and the power board are bonded;
(f2) returning the third latch and the fourth latch to the latched state, and allowing the connected-panel structure and the first pressing module to be positioned between the second base plate and the second planes; and
(f3) moving the second elastic member to push against the first base plate so that the first base plate is in contact with the second planes.

17. The power module assembly method according to claim 10, wherein the step (g) comprises sub-steps:
(g1) performing a cooling process to the connected-panel structure, the first pressing module and the second pressing module after the high-temperature curing process;
(g2) allowing the third latch and the fourth latch to be in the open state to remove the second pressing module;
(g3) flipping the first pressing module and the connected-panel structure; and
(g4) allowing the first latch and the second latch to be in the open state to remove the first pressing module.
